(19) United States
(12) Patent Application Publication
(10) Pub. No.: US 2018/0293283 A1
(43) Pub. Date: Oct. 11, 2018

(54) SYSTEMS AND METHODS OF CONTROLLED SHARING OF BIG DATA

(71) Applicants: Marin LITOIU, Toronto (CA); Mark SHTERN, Toronto (CA)

(72) Inventors: Marin LITOIU, Toronto (CA); Mark SHTERN, Toronto (CA)

(21) Appl. No.: 15/525,636

(22) PCT Filed: Nov. 13, 2015
(86) PCT No.: PCT/CA2015/051182

§ 371 Date: May 10, 2017

Related U.S. Application Data
(60) Provisional application No. 62/080,226, filed on Nov. 14, 2014.

(51) Int. Cl. G06F 17/30

(52) U.S. Cl. CPC G06F 17/30539; G06F 2216/03; G06F 17/30303; G06F 17/30569

(57) ABSTRACT

Methods and systems for controlled data sharing are provided. According to one example, a data provider defines one or more data policies and allows access to data to one or more data consumers. Each data consumer submits analytics tasks (jobs) that include two phases: data transformation and data mining. The data provider verifies that data is trans-formed (e.g., anonymized) according to the data policies. Upon verification, the data consumer is provided with access to the results of the data mining phase. An ecosystem of data providers and data consumers can be loosely coupled through the use of web services that permit discovery and sharing in a flexible, secure environment.

### FIELD OF THE INVENTION

The field of the invention is data brokering, data sharing and access control and, in particular, privacy control.

### BACKGROUND

The following description includes information that may be useful in understanding the present invention. It is not an admission that any of the information provided herein is prior art or relevant to the presently claimed invention, or that any publication specifically or implicitly referenced is prior art.

Today, we are living in an era of Big Data, where 90% of the data in the world has come into existence since 2010. Many Big Data applications are being developed through a collaboration between data providers and analytics providers. For instance, IBM reported that mortality decreased when hospital patient data was analyzed. As well, a service called Shoppycat recommends retail products to social networking users based on the hobbies and interests of their friends. All these examples require the integration between data provider and data consumer applications. To facilitate the ecosystem between the data provider and the data consumer, there is a need for large data providers to develop secure mechanisms for enabling access to their data.

Researchers have attempted to address the matter of privacy protection for Big Data. As a result, there are many techniques for data anonymization. Compliance becomes more complex in Big Data contexts due to the large amount of data that is un-structured or semi-structured. Moreover, the data owner may not have sufficient knowledge about the sensitivity of data stored on its servers. As well, Big Data can have massive volumes and high speed and because typical analytics needs do not require all data, it means that structuring and anonymizing all existing data may lead to inefficient uses of resources.

In order to extract value from Big Data, a data provider typically shares data among many data consumers. As such, data sharing becomes an important feature of Big Data platforms. However, privacy is an obstacle preventing organizations from implementing data sharing solutions. As well, the data owner is traditionally responsible for preparing data before releasing it to third party. The preparation data for release is a complex task and can become a further obstacle.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for a system that allows for controlled access to Big Data, allowing for the data to be transformed as desired and to mitigate some of the obstacles to data sharing.

### BRIEF DESCRIPTION OF THE DRAWINGS

Various objects, features, aspects and advantages of the inventive subject matter will become more apparent from the following detailed description of preferred embodiments, along with the accompanying drawing figures in which like numerals represent like components.

FIG. 1 is a block diagram of a system for controlled sharing of data in accordance with an example of the present specification;

FIG. 2 is a sequence diagram of the system in operation according to an exemplary method of the present specification, of FIG. 1; and

FIG. 3 is a flowchart of the data provider-side and data consumer-side runtime functions, according to an example of the present specification.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial query protocols, or other electronic information exchanging methods. Data exchanges can be conducted over a packet-switched network, the Internet, LAN, WAN, VPN, or other type of packet switched network.

One should appreciate that the systems and methods of the inventive subject matter provide various technical effects, including providing data access and analysis functions without requiring copying, mirroring or transmitting large data sources for use by a client.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Aspects of the inventive subject matter as applied to controlled data sharing are described in the inventors' papers “Toward an Ecosystem for Precision Sharing of Segmented Big Data”, “Enabling an Enhanced Data-as-a-Service Ecosystem”, and “A runtime sharing mechanism for Big Data platforms”, and in US Patent Publication No. US 2015-0288669 A1, all of which are incorporated by reference herein in their entirety.

The term “Big Data” is generally used to describe collections of data of a relatively large size and complexity, such that the data becomes difficult to analyze and process within a reasonable time, given computational capacity (e.g., available database management tools and processing power). Thus, the term “Big Data” can refer to data collections measured in gigabytes, terabytes, petabytes, exabytes, or larger, depending on the processing entity's ability to handle the data. As used herein, and unless the context dictates otherwise, the term “Big Data” is intended to refer to collections of data stored in one or more storage locations, and can include collections of data of any size. Thus, unless the context dictates otherwise, the use of the term “Big Data” herein is not intended to limit the applicability of the inventive subject matter to a particular data size range, data size minimum, data size maximum, or particular amount of data complexity, or type of data which can extend to numeric data, text data, image data, audio data, video data, and the like.

The inventive subject matter can be implemented using any suitable database or other data collection management technology. For example, the inventive subject matter can be implemented on platforms such as Hadoop-based technologies generally, MapReduce, HBase, Pig, Hive, Storm, Spark, etc.

In this specification, methods and systems for controlled data sharing are provided. Data sharing according to the disclosed techniques between different data consumers can exempt the data provider from the task of transforming or anonymizing the data. According to one example, a data provider defines one or more data privacy policies and allows access to data to one or more data consumers (also referred to as “end users” or “analysts”). Each data consumer submits analytics tasks (jobs) that include at least two phases: data anonymization and data mining. In one example, the jobs run on the infrastructure of the data provider, near the actual data source, reducing network bottlenecks while permitting the data to be retained on the data provider's premises. The data provider verifies that data is transformed or anonymized according to the privacy policies. Upon verification, the data consumer is provided with access to the results of the data mining phase. An ecosystem of data providers and data consumers can be loosely coupled through the use of web services that permit discovery and sharing in a flexible, secure environment.

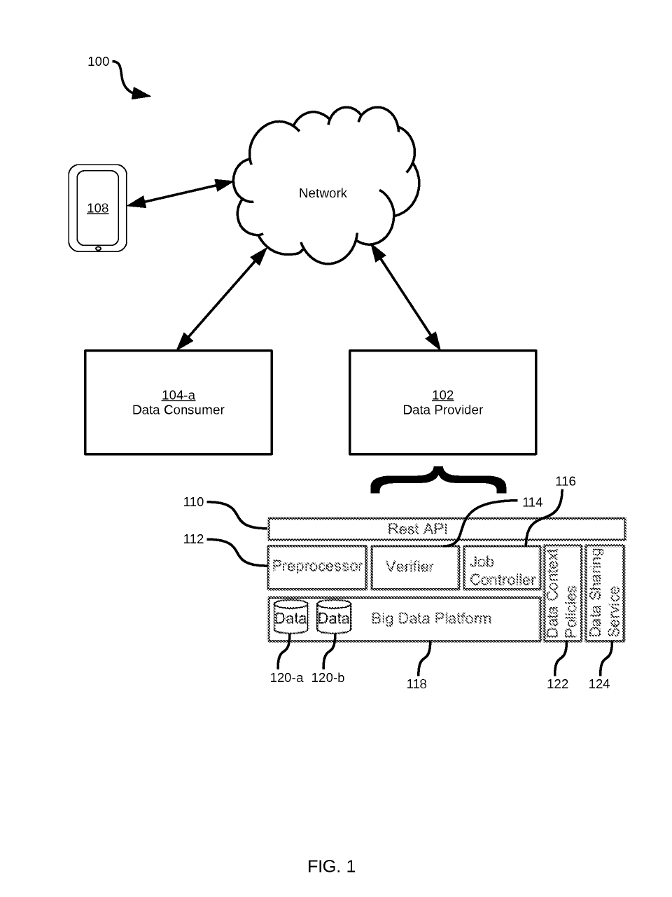

FIG. 1 provides an overview of exemplary ecosystem 100 of the present specification. The ecosystem 100 includes one or more electronic devices 108 (a single electronic device 108-a is shown in FIG. 1) (e.g., through which a user or a data analyst access the system), a data provider server 102, and one or more data consumer servers 104 (again, a single data consumer server 104-a is shown in FIG. 1). In other examples, the ecosystem 100 can also include one or more resellers (not shown) between the electronic device 108, data consumer server 104 and the data provider server 102.

In embodiments, the ecosystem 100 can include more than one data provider servers 102, which can be communicatively connected to any of the data consumer servers 104 and/or to the electronic devices 108. Thus, a user interface of the electronic device 108 can access data provided by data provider server 102 via data consumer servers 104.

Each of the components of the ecosystem 100 (i.e., the electronic device 108, the data provider server 102, data consumer servers 104, etc.) can be communicatively coupled with each other via one or more data exchange networks (e.g., Internet, cellular, Ethernet, LAN, WAN, VPN, wired, wireless, short-range, long-range, etc.).

The data provider server 102 can include one or more computing devices programmed to perform the data provider's functions including receiving data mining request from data consumer servers 104 (e.g. via electronic devices 108) and returning the results to the corresponding data consumer servers 104 and/or electronic devices 108 Thus, the data provider server 102 can include at least one processor, at least one non-transitory computer-readable storage medium (e.g., RAM, ROM, flash drive, solid-state memory, hard drives, optical media, etc.) storing computer readable instructions that cause the processors to execute functions and processes of the inventive subject matter, and communication interfaces that enable the data provider server 102 to perform data exchanges with electronic devices 108 and/or data consumer servers 104. The computer-readable instructions that the data provider server 102 uses to carry out its functions can be database management system instructions allowing the data provider server 102 to access, retrieve, and present requested information to authorized parties, access control functions, etc. The data provider server 102 can include input/output interfaces (e.g., keyboard, mouse, touchscreen, displays, sound output devices, microphones, sensors, etc.) that allow an administrator or other authorized user to enter information into and receive output from the data provider 102 devices. Examples of suitable computing devices for use as a data provider server 102 can include server computers, desktop computers, laptop computers, tablets, phablets, smartphones, etc.

The data provider server 102 can include the databases (e.g. the data collections) being made accessible to the electronic devices 108 and data consumer servers 104. The data collections can be stored in the at least one non-transitory computer-readable storage medium described above, or in separate non-transitory computer readable media accessible to the data provider server 102's processor(s). In embodiments, the data provider server 102 can be separate from the data collections themselves (e.g., managed by different managing entities). In these cases, the data provider server 102 can store a copy of the data collections which can be updated from the source data collections with sufficient frequency to be considered “current” (e.g. via a periodic schedule, via “push” updates from the source data collections, etc.). Thus, the entity or administrator operating the data provider server 102 can be considered to be the entity responsible for accepting and running the query jobs, regardless of actual ownership of the data.

Administrators or other members of the data provider server 102 can assess their data (e.g., Big Data), and decide which portions of it are to be made accessible to some degree. For example, the determination can be regarding the portions of data to be made available outside an organization, among various business units internal to an organization, etc. The size and scope of the portions can be determined entirely a priori, or can be determined at run-time based on information provided by the data consumer server 104 (e.g., via electronic device 108). These logical partitions of the physical data are referred to herein as data sources. Establishing restricted subsets of the data for access facilitates data access control, segmentation, and transformation/abstraction for the data provider server 102.

To make the data available to users (via electronic devices 108) and data consumer servers 104, the data provider server 102 defines its data sources and vectors of access. The data provider server 102 can also provide information about all available data sources (e.g., what data is provided, which “provider interface” the format and data type of the incoming data, the approximate size of the data, cost definitions, etc.) through a web service API. Users' interaction with the data sources is enabled through this API. In embodiments, the web service can be specified to be standardized across all providers, allowing for easy integration.

A user interface accessed through the electronic device 108 can implement the prescribed “provider interface”, and, according to one example, submit their compiled code to the provider's web service along with any required parameters. In other examples, an interactive user interface can populate data fields, using Boolean logic in one example, from user input to enable storage, retrieval and entry of jobs or requests. The data analyst can, via the user interface, monitor the status of their job or retrieve the results through the same web service. The user interface can run their own client for communicating with the web service, or use a client offered through a Software-as-a-Service (SaaS) delivery model, where jobs are submitted and monitored through a client-facing user interface with the actual communication handled behind-the-scenes.

The user interface of the electronic device 108 can comprise one or more computing devices that enables a user or data analyst to access data from data consumer server 104 and/or data provider server 102 by creating and submitting query jobs. The electronic device 108 can include at least one processor, at least one non-transitory computer-readable storage medium (e.g., RAM, ROM, flash drive, solid-state memory, hard drives, optical media, etc.) storing computer readable instructions that cause the processors to execute functions and processes of the inventive subject matter, and communication interfaces that enable the electronic device 108 to perform data exchanges with data provider server 102 and data consumer server 104. The electronic device 108 also includes input/output interfaces (e.g., keyboard, mouse, touchscreen, displays, sound output devices, microphones, sensors, etc.) that allow the user/data analyst to enter information into and receive output from the system 100 via the electronic device 108. Examples of suitable computing devices for use as an electronic device 108 can include servers, desktop computers, laptop computers, tablets, phablets, smartphones, smartwatches or other wearables, “thin” clients, “fat” clients, etc.

To access or obtain data from the data provider server 102, the electronic device 108 can create a query job and submit it to the data provider 102 (either directly or via a data consumer server 104, depending on the layout of the ecosystem 100).

Still with reference to FIG. 1, it will be appreciated that the big data system 100 (ecosystem) enforces privacy policies on data analytics workloads. The system includes a data provider server 102, shown in FIG. 1, that is responsible for providing the big data platform and the data. The one or more data consumer servers 104 develop and submit data mining requests to the data provider server 102. A typical big data analytics process performed by the data consumer server 104 includes a data preparation phase. One objective of data preparation phase is to prepare data for a data mining request. During this phase, the input data is pre-processed to extract tuples (e.g., where the original data is un-structured), to reduce noise and handle missing values (data cleansing), then to remove the irrelevant or redundant attributes (relevance analysis) and finally to generalize or normalize data (data transformation).

According to examples of the present specification, the data preparation phase is extended to include a transformation (anonymization) step. In this step, the data consumer server 104 provides anonymization customized to an analytics workload.

To prevent data breaches and enforce privacy, the data provider server 102 can monitor whether the data consumer server 104 complies with its privacy policies. The data provider server 102 monitors the anonymization process. The data consumer server 104 provides the preparation function or process as a separate process/job in a domain specific language (DSL). The DSL helps to reduce the complexity of privacy compliance verification process. When the data consumer server 104 defines the data preparation function using the DSL, it also specifies a schema of extracted facts. In other words, for each attribute it will specify its semantic, such as city, name, SIN etc. The schema definition can be similar to a relational database schema and is defined for the output of a data cleansing phase. The data preparation job expressed in DSL can be checked for compliance without actually running the job, by performing a static analysis. Where the static analysis does not detect breaches, the data provider server 102 can then run the DSL transformation on the actual data to detect if it causes a violation of privacy policies. The data provider server 102is also responsible to verify that the schema aligns with underline data. The key properties of DSL are discussed below, with reference to the preprocessor module 112.

To reduce the risk that the automatic private policy verification process fails to catch leakage of private information, the data preparation function can run first on a subset of data (a test dataset) that contains all previously identified private information. In case a failure is detected on the test dataset, the data mining request can be denied or further error handling techniques can be deployed.

Since the verification of privacy compliance can be done in parallel with the execution of data mining requests and because Big Data jobs usually run for a long time, the verification process does not necessarily introduce a significant delay in the overall process.

Moreover, data mining jobs often require mixing data from different sources. In such cases, several data preparation jobs need to be created. The data provider server 102 can validate each data preparation process in sequence. This strategy can protect against dataset linkage attacks even if it increases complexity.

The main components of the data provider server 102 include a REST API 110, a preprocessor module 112, a verifier module 114, a job controller module 116, a Big Data platform 118 comprising one or more databases 120-a, 120-b, etc., a data context policy module 122, and a data sharing service module 124.

The REST API 110 is a “restful” API that allows data consumer servers 104 to submit analytic jobs together with a corresponding data preparation job. The data consumer server 104 can track the job progress and get the result of data mining requests using the REST API 110. In one example, the REST API 110 is the only access point to the Big Data platform 118.

The preprocessor module 112 is responsible for transforming the original data into anonymized data using the transformation defined in the DSL language program or other suitable program. The preprocessor module 112 can be invoked after the verifier module 114, discussed in more detail below, validates the DSL using static analysis and augments the transformation to include supplementary information. During the transformation process, the preprocessor module 112 sends the produced dataset (including supplementary data) to the verifier module 114 and then to the data mining requests.

The preprocessor module 112 is a data parser and filtering component. The input for the preprocessor module 112 is a stream of un-structured data and a transformation specified using DSL. The output is a stream of tuples. When one pass of data is sufficient for implementing the privacy protection, then the preprocessor module 112 can follow a streaming paradigm. When streaming is used, a typical data flow is to read one input record, parse it, transform it and in parallel send to the verifier module 114 all intermediate and final records. Where this process is insufficient to meet privacy goals, a second pass over data may be required.

The ability of the preprocessor module 112 to satisfy the data preparation needs of a data customer server 104 depends on the flexibility and expressivity of DSL. At the same time, in order for the verifier module 114 to effectively evaluate the correctness of a given data transformation and to limit the vector of possible attacks (such as encrypting data or sending it over network), the language should be simple and limited. According to one example of the present specification, the following requirements for DSL language have been identified: 1) the ability to specify the beginning and end of every phase of the transformations such as data parsing, anonymization, etc.; 2) the ability to specify the schema of extracted tuples and to specify how tuples will be anonymized; 3) the ability to specify additional information required by the verifier module 114 in a programmatic way; and 4) including high-level abstraction for simplification of the anonymization process. The DSL language as mix declarative style for defining schema and procedural style for specifying how and what information to extract from un-structured data.

The verifier module 114 performs the static analysis of the DSL program to verify that DSL transformation produces a data set aligned with data context policies. Depending on the underlying policies, the verifier module 114 can modify the DSL program to attach additional transformations to comply with the policies. The verifier module 114 is also responsible for validating that DSL correctly defines extracted facts from input dataset. The verifier module 114 runs in either streaming and batch data processing style and can run in parallel with the data mining requests.

The job controller module 116 is responsible for coordinating different components of the data provider server 102. The job controller module 116 is also responsible for monitoring job execution, scheduling execution of data processing tasks on the preprocessor module 112 and scheduling the verification tasks upon the completion of data preparation process. The job controller module 116 also feeds output data from the preprocessor module 112 to corresponding data mining requests. In addition, the job controller module 116 is responsible to schedule data preparation process on the test dataset for verification of privacy policies. To achieve this, the job controller module 116 can have a tied integration with data sharing service module 124, described in more detail below.

The Big Data platform 118 provides both access to stored data and to distributed processing. For instance, the Hadoop ecosystem is a popular example of big data platform.

The data context policies module 122 is a service that manages privacy and access policies on specific data types (e.g. SIN, name, address, age, etc.) and can be specific to a data provider's attributes or group settings. For instance, the access policies may require that a data consumer may have access only to cities and movies. Or that a data mining request should comply with 10-anonymity. In one example, XCAML 4 is a flexible approach for defining such data context polices. The data provider server 102 may be configured to require additional access control policies using data sharing facilities. Many data sharing policies are encompassed within the scope of the present specification.

The data sharing service module 124 is responsible for enabling fine-grained control over what data is shared. The data sharing service module 124 enables analytics tasks to run on the infrastructure co-located or near the data provider server 102. The data sharing service module 124 also provides services for authorization and authentication of data consumer servers 104. A tool for precision sharing of segmented data is one example of the data sharing service module 124 (disclosed in U.S. provisional application No. 61/976,206, filed Apr. 7, 2014, incorporated herein by reference in its entirety).

The data provider server 102 automatically stores all submitted DSL transformations for future auditing. In addition, approved DSL transformations can be used for constructing and improving test datasets due to the fact that DSL transformations contain information about the type of extracted data needed by data consumer servers 104. Constructing test datasets is discussed in further detail below.

To prevent unauthorized access to sensitive data, safeguards can be deployed to prevent third party code such as data mining jobs or data preparation processes from being received by the data provider server 102 using, for example, network communication channels.

The verifier module 114 is responsible for validating the compliance of both DSL and dataset with the data provider server 102 policies. According to one example of the present specification, the data provider server 102 has two ways to address a violation of policies. The first one is to cancel a job when the first violation is discovered. Such an approach may not be practical in all cases due to large volume of data and because not all policies require cancelling. An alternative approach to filter data which violates the policies might be more practical in some cases. The proposed system can accommodate both approaches for general policy violation.

The verifier module 114 includes one or more independent components such as a DSL verifier and enhancer, a schema verifier and an anonymization verifier.

The DSL verifier and enhancer is a static analyzer that attempts to discover non-compliance with data provider polices. In addition, this component is responsible for modifying the transformation script to include additional information and steps to allow verification of privacy policies.

The Schema verifier validates data compliance with schema on each step (such as parsing, filtering, generalization) of transformation. It may be part of the verifier module 114 or part of the preprocessor module 112 (in such scenario, verification happens immediate after data cleaning step). There is a decrease of network traffic when the schema verifier module is included in the preprocessor module 112. This also allows the filtering of data fields that are not compliant with schema. Since the schema verifier checks whether the actual data complies with specific required data type, the data provider server 102 can develop rules to verify this. Many verification rules can be developed using open source database such as WorDnet, Freebase, and the like. Since the schema verifier may require a significant time for verification between data and schema, to avoid delays, the schema verifier can run outside of the preprocessor module 112.

The anonymization verifier can be deployed as a separate process or part of the final step of the preprocessor module 112. The anonymization verifier performs the following actions: 1) ensure that data parsing step (extraction of tuples from unstructured/semi-structured data) from the data preparation process does not modify the original data. This test mitigates some sort of remapping/encoding attacks, where private data can be encoded using non-private data; 2) verify whether the constructed dataset meets the data provider's privacy policies. This test is dependent on the required anonymization methodology. In the case of k-anonymity, for example, the test verifies that tuples for each person contained in the anonymized dataset cannot be distinguished from at least k-1 individuals whose tuples also appear in the anonymized dataset. When a data-mining request consumes data from different data sources then the verifier module 114 can verify the anonymization based on the composition of the extracted information from different sources. Therefore, this ecosystem can be used in federation with other similar ecosystems.

An additional, optional step to protect against the leakage of private information is the assessment of data preparation process on a test dataset. During such assessment, the verifier module 114 can check if any part of private information appears in the elements of constructed tuples. According to one example, the data consumer server 104 is obligated to specify all personal information to be extracted. To verify this and ensure that the transformation process was correct, the system 100 can run the data preparation process together with the verification process on a test dataset, which is a subset of original dataset. For each test dataset, there is a meta-data that includes information about personal identification fields and known attributes and their types. When the verifier module 114 has both the meta-data and the dataset constructed after preprocessing, it can better validate the anonymization and whether the data consumer server 104 correctly specifies identifiable information and a correlation between schema and the dataset.

It will be appreciated that the disclosed examples introduce flexibility and data mining efficiency. The transformation or anonymization step can be de-centralized such that the data consumers (end users or analysts) need only have sufficient information about the structure of the desired data, and know how to anonymize a data set and still get meaningful results. A data producer verifies that the pre-processing and anonymization proposed by the data consumer is compliant with a privacy policy or other policies.

Disclosed techniques can also avoid the construction of special, anonymized data sets before granting access to data consumers. This can improve storage utilization because there is no need to generate storage-intensive or stale data sets and can simplify the maintenance of anonymized data sets (such as synchronization with updated data and construction of anonymized data sets for unused data). The disclosed techniques can also provide for the creation of anonymized data sets at runtime, or on demand, and only for the data required by the data consumer for the specific analytic task.

According to disclosed examples, the data provider delegates the preprocessing of data, including the anonymization functions, to the data consumer. The data provider's responsibility is to verify that data is pre-processed and sufficiently anonymized before the data consumer is granted access to the results of a data mining request. Generally, data providers are more willing to share data when the anonymization is delegated to a third party because anonymization can be computationally expensive. For instance, to construct a k-anonymous data set with minimum suppressing information is a NP-hard problem, however, to verify that a data is k-anonymous is a trivial and polynomial problem.

It will be appreciated that k-anonymity is an example of a technique that can be used for data anonymization in accordance with the methods and systems disclosed in the present specification. The same approach can be used with a different anonymization technique without departing from the scope of the present specification. Use of the term “anonymization” generally refers to the process of removing or protecting personally identifiable information from a data set.

Similarly, anonymization is an example of a transformation that can be used in accordance with the methods and systems disclosed in the present specification. The present specification is not limited to anonymization of data sets and it will be appreciated that use of the term “transformation” can extend to any filter, conversion or other translation of data.

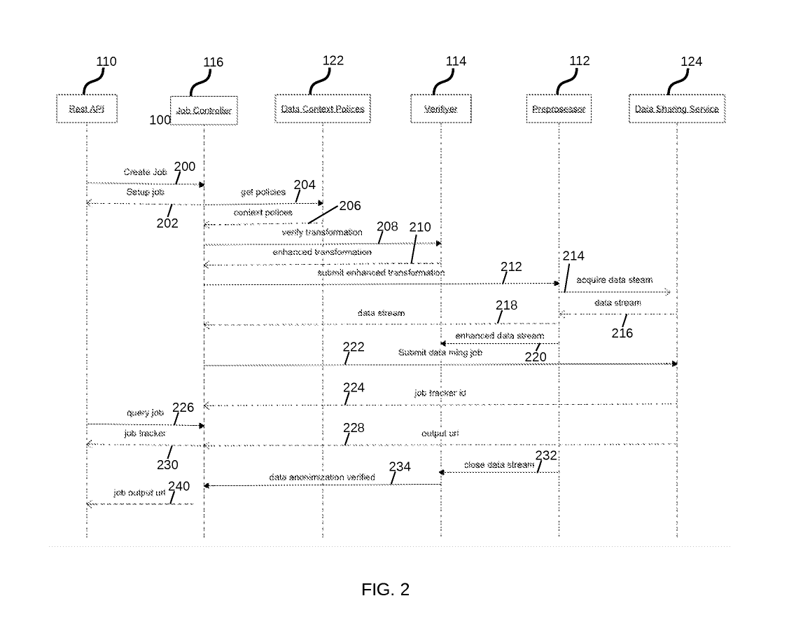

FIG. 2 provides an illustrative example of a data mining request (analytics or query job 400, not shown in FIG. 2) generated by the data consumer server 104 (e.g., via the electronic device 108). The query job is created at 200 via the REST API 110 provided by a data provider server 102 and forwarded to the job controller module 116. The query job 400 is made of two parts: the transformation part 401 and the analytics part 402. The job controller module 116 analyzes the transformation part 401 and then queries the data context policies module 122 at 204. The data context policies module 122 responds with the context policies at 206. The job controller module 116 then passes the transformation part 401 and the context policies at 208 to the verifier module 114. The verifier module verifies that the transformation part 401 is compliant with the context policies and, in one example, enhances the transformation to comply with the context policies. The enhanced transformation is then returned to the job controller module 116 which then forwards it to the preprocessor module 112. The preprocessor module 112 transforms the data and requires a data stream, at 214, from the data sharing service module 124. The stream, at 216, is returned to the job controller module 116 which submits the analytics part 402 through a request, at 222. The data sharing service module 124 starts processing the analytics part 402 and returns a job tracker id at 224 to the REST API 110. The data consumer server 104 can now query the progress of the analytics part 402 through a request, at 226, and can get back the status through an output URL at 228. Finally, when the data sharing service module finishes processing the analytics job (402), it closes the data stream at 232, and after the anonymization is verified at 234, the results are returned to the client at 240.

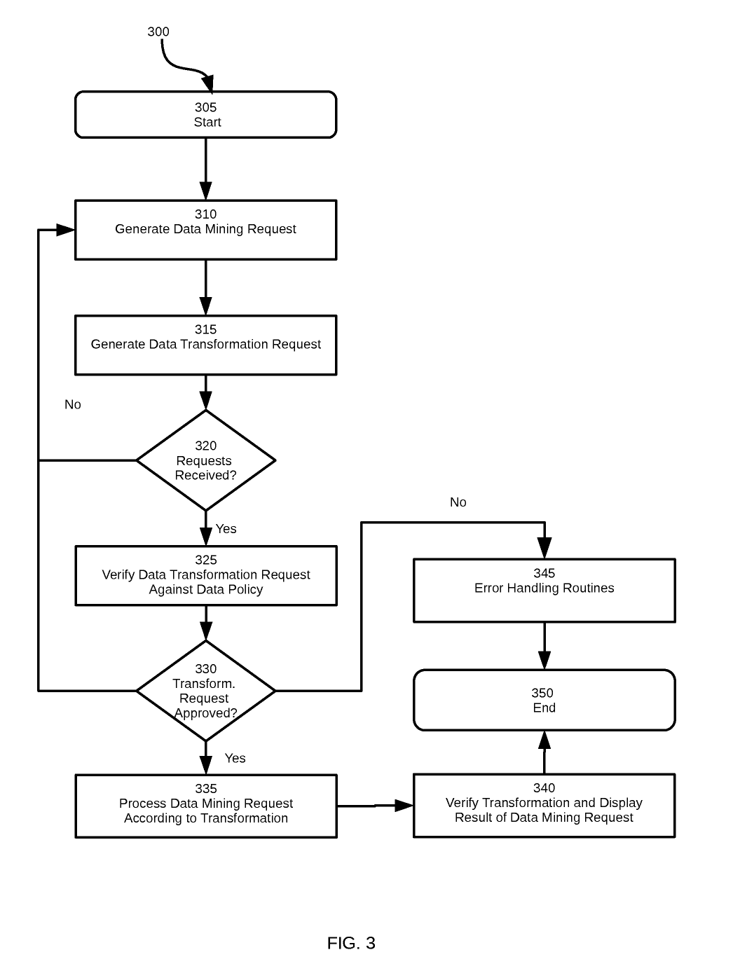

A flowchart illustrating an example of a disclosed method of controlled data sharing is shown in FIG. 3. This method can be carried out by applications or software executed by, for example, the processor of the data provider server 102 and/or data consumer servers 104. The method can contain additional or fewer processes than shown and/or described, and can be performed in a different order. Computer-readable code executable by at least one of the processors to perform the method can be stored in a computer-readable storage medium, such as a non-transitory computer-readable medium.

With reference to FIG. 3, a method 300 starts at 305 and, at 310, the data consumer server 104 generates a data mining request. At 315, the data consumer server 104 generates a data transformation request. At 320, the data provider server 102 receives the requests over the network and, at 325, verifies the data transformation request is consistent with a data policy, such as an anonymization policy. If the data transformation request is approved by the data provider server 102 at 330, then, at 335, the data mining request is processed according to the verified data transformation function that has been verified against the data policy. At 340, the result of the data mining request—data from the big data platform 118 that has been transformed according to the data policy—is verified and/or provided to the data consumer server 104. If the request is not approved, or the verification fails, then error handling routines at 345 can provide feedback or other response to the data consumer server 104. At 350, the method ends.

The output of the electronic device 108 is displayed at step 340 and can be presented in tables, text, graphs, bars, charts, maps and other visual formats. The output can include one or more of these visual elements and can be interactive. For example, touching (or clicking) at a location on the touch-screen (or other display) of the electronic device 108 that is associated with a dataset result can cause a sorting or filtering function to be performed. Responsive to the touch event, the display of the electronic device 108 can be updated dynamically. In this regard, according to one example, touching at a location can dynamically update all elements, whether by sorting, filtering, etc., connected to the element associated with the touch (or click).

The skilled reader will appreciate that the exemplary ecosystem 100 of the present specification can be adapted to capture and track user interactions or events at the electronic device 108 by the user or the data analyst accessing the system. Such events can extend to data consumption, and can include analytics data such as content source accessed, anonymization techniques applied, date and time information, location information, content information, user device identifiers, etc., related to each event or interaction. Information related to a usage session can be captured and monitored periodically at a specified interval, or upon occurrence of a threshold number of events, and/or at other times. The information related to a usage session can be stored by the data provider server 102, according to one example.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method including the steps of: at a data consumer server including a first processor, a first memory, and a first network interface device. The method also includes generating a data mining request. The method also includes generating a data transformation request associated with the data mining request according to a data policy. The method also includes at a data provider server including a second processor, a second memory, and a second network interface device, the data provider server maintaining a data source and connected to the data consumer server over a network, receiving, over the network, the data mining request and the data transformation request; verifying the data transformation request against the data policy; responsive to the verifying, approving the data mining request; and when the data mining request is approved, at the data consumer server, receiving data from the data source responsive to the data mining request and transforming the received data according to the data transformation request. Other embodiments of this aspect include corresponding computer systems, apparatus, and computer programs recorded on one or more computer storage devices, each configured to perform the actions of the methods.

Implementations may include one or more of the following features. The method further including the steps of: at an electronic device including a processor, a memory, a network interface and a display, receiving the data responsive to the data mining request; generating a result view based on the data responsive to the data mining request; and providing the result view on the display. The method where the data source includes non-structured data and the providing data step further includes the steps of: pre-processing the data to extract tuples, data-cleansing the data to reduce noise and handle missing values, removing irrelevant and redundant attributes from the data, normalizing the data, and transforming the data according to the data policy. The method where the data policy is an anonymization function and the transforming step is performed at run-time. The generating a data transformation request can include defining a transformation function using a DSL schema. The verifying can include analyzing the DSL to verify the transformation produces a data set aligned with the data policy. Implementations of the described techniques may include hardware, a method or process, or computer software on a computer-accessible medium. The generating a data mining request may include providing a user interface on an electronic device for creating, tagging, and retrieving stored data mining requests; receiving input from the user interface; populating the data mining request from the input. The stored data mining request may be a template data mining request that is stored apart from data responsive to the stored data mining request.

According to one example, the method can include the steps of receiving data associated with events at the user interface of the electronic device and storing the data associated with events at an analytics data store maintained the data provider server. Moreover, according to a further example, the result view can include one or more visual interaction elements such as a chart, a graph, and a map. According to this example, the method can include receiving input associated with the visual interaction element, applying a filtering function and/or a sorting function, and dynamically updating the result view on the display.

One general aspect includes at least one non-transitory computer-readable storage medium storing instructions that, when executed by at least one processor, cause the at least one processor to: receive, over a network, a data mining request and a data transformation request; verify the data transformation request against a data policy; responsive to the verifying, approve the data mining request; and when the data mining request is approved, provide data from the data source responsive to the data mining request for transformation according to the data transformation request. Other embodiments of this aspect include corresponding computer systems, apparatus, and computer programs recorded on one or more computer storage devices, each configured to perform the actions of the methods.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method comprising the steps of:
at a data consumer server comprising a first processor, a first memory, and a first network interface device,
generating a data mining request;
generating a data transformation request associated with the data mining request according to a data policy;
at a data provider server comprising a second processor, a second memory, and a second network interface device, the data provider server maintaining a data source and connected to the data consumer server over a network,
receiving, over the network, the data mining request and the data transformation request;
verifying the data transformation request against the data policy;
responsive to the verifying, approving the data mining request; and
when the data mining request is approved, at the data consumer server:
receiving data from the data source responsive to the data mining request;
transforming the received data according to the data transformation request.

2. The method of claim 1 further comprising the steps of:
at an electronic device comprising a processor, a memory, a network interface and a display,
receiving the data responsive to the data mining request;
generating a result view based on the data responsive to the data mining request; and
providing the result view on the display.

3. The method of claim 1 wherein the data source comprises non-structured data and the transforming data step further comprises the steps of:
pre-processing the data to extract tuples;
data-cleansing the data to reduce noise and handle missing values;
removing irrelevant and redundant attributes from the data;
normalizing the data; and
transforming the data according to the data policy.

4. The method of claim 3 wherein the data policy is an anonymization function and the transforming step is performed at run-time.

5. The method of claim 1 wherein the generating a data transformation request further comprises the steps of:
defining a transformation function using a DSL schema; and
wherein the verifying comprises the steps of:
analyzing the DSL schema to verify the transformation produces a data set aligned with the data policy.

6. The method of claim 1 wherein generating the data mining request comprises:
providing a user interface on an electronic device for creating, tagging, and retrieving stored data mining requests;
receiving input from the user interface;
populating the data mining request from the input.

7. The method of claim 6 wherein the stored data mining request is a template data mining request that is stored apart from data responsive to the stored data mining request.

8. The method of claim 6 further comprising the steps of:
receiving data associated with events at the user interface of the electronic device;
storing the data associated with events at an analytics data store maintained the data provider server.

9. The method of claim 2 wherein the result view comprises one or more visual interaction element selected a chart, a graph, and a map, the method further comprising the steps of:
receiving input associated with the visual interaction element;
applying a function selected from one of: a filtering function and a sorting function; and
dynamically updating the result view on the display.

10. At least one non-transitory computer-readable storage medium storing instructions that, when executed by at least one processor, cause the at least one processor to:
receive, over a network, a data mining request and a data transformation request;
verify the data transformation request against a data policy;
responsive to the verifying, approve the data mining request; and
when the data mining request is approved, provide data from the data source responsive to the data mining request for transformation according to the data transformation request.
